(19) United States
(12) Patent Application Publication
(10) Pub. No.: US 2007/0065062 A1
(43) Pub. Date: Mar. 22, 2007

(54) Intermediate bearing for a drive shaft and method of manufacturing the same

(76) Inventor: Hans Roth, Salem (DE)

Correspondence Address: KLAUS J. BACH, 4407 TWIN OAKS DRIVE, MURRYSVILLE, PA, 15668, US

(21) Appl. No.: 11/522,480

(22) Filed: Sep. 15, 2006

(30) Foreign Application Priority Data
Sep. 16, 2005 (DE) 10 2005 044 324.9

(51) Int. Cl. F16C 27/00

(52) U.S. Cl. 384/536

(57) ABSTRACT

In an intermediate bearing for a drive shaft and the manufacture thereof wherein the bearing includes a bearing carrier having mounting surfaces and a support opening for accommodating an elastic support part resiliently supporting the drive shaft, the support opening is manufactured at least in a vertical direction with an extension exceeding the diameter of the elastic support part which is vulcanized into the support opening at a desired level over the level of the mounting surfaces while, at the same time, any space in the support opening around the elastic support part is filled with vulcanizing material for firmly supporting the elastic support part in the support opening at a desired height level.

### BACKGROUND OF THE INVENTION

The invention relates to an intermediate bearing for a drive shaft with a bearing carrier which includes a mounting surface areas for its mounting to a component supporting the driveshaft and an elastic compensation part disposed in a support opening of the bearing carrier.

Intermediate bearings for supporting, on a vehicle body part, multi-section drive shafts as they are used in motor vehicles for the transmission of power from a drive unit to a drive axle, are known in large numbers. The elastic compensation part may be a bellows or for example or an intermediate toroidal ring disposed between inner and outer annular support members. Intermediate bearings for various types of drive shafts are described for example in DE 43 20 642 C1, in DE-AS 24 57 941 and in the German Utility Model 6 919 078.

Depending on the installation position of the drive shaft, it is advantageous if the height of the bearing support is adjustable by an adjustment of the center of the bearing, that is, that the position of the center of the compensation part supporting the drive shaft is adjustable. Conventionally, the level of the bearing support is adjusted by welding metal plates onto the mounting surfaces of the bearing carrier. However, disadvantages of this type of level adjustment are, on one hand, the additional manufacturing expenditures for the welding and, on the other hand, the fact that, in the area of the welded metal plates, increased corrosion, particularly crevice corrosion, between the support part, the metal plates and bearing carrier takes place.

It is the object of the present invention to provide an improved intermediate bearing for drive shafts and an improved method for its manufacture.

### SUMMARY OF THE INVENTION

In an intermediate bearing for a drive shaft and the manufacture thereof wherein the bearing includes a bearing carrier having mounting surfaces and a support opening for accommodating an elastic support part resiliently supporting the drive shaft, the support opening is manufactured at least in a vertical direction with an extension exceeding the diameter of the elastic support part which is vulcanized into the support opening at a desired level over the level of the mounting surfaces while, at the same time, any space in the support opening around the elastic support part is filled with vulcanizing material for firmly supporting the elastic support part in the support opening at a desired height level.

It is an important advantage of the intermediate bearing according to the invention, that it can be manufactured easily and at low costs. It is also very advantageous that, by its design, it is less subject to corrosion. Furthermore, the dimensional accuracy is improved because the welding of spacer plates is eliminated.

In an advantageous embodiment of the intermediate bearing according to the invention, the basis opening has an increased diameter in vertical direction so that the opening has a vertically oriented oval shape.

Preferably, the bearing carrier is formed by a deep drawn metal sheet metal structure.

In a preferred embodiment of the intermediate bearing according to the invention, the mounting surfaces are formed at support areas of the bearing carrier where the strength of the carrier structure has been increased by folding over and thereby doubling the sheet metal structures.

Furthermore, with the present invention, a method for manufacture of an intermediate bearing for drive shafts is provided with mounting surfaces for attachment to a support component on which the drive shaft is to be supported, and an elastic adjustment component of a vulcanized material which is received in the basic opening formed in the bearing carrier and in which the drive shaft is resiliently supported so as to be capable of accommodating vibrations. For level adjustment, the center of the bearing can be positioned at different levels with respect to the mounting surface.

In accordance with the invention, the support opening of the bearing carrier is higher than it is wide with regard to the elastic adjustment component and the elastic adjustment component is vulcanized in accordance with the predetermined extent of desired level compensation at different heights with respect to the bearing carrier mounting surface and any space remaining between the elastic adjustment component and the support opening is filled by additional material while the elastic adjustment component is vulcanized into the support opening of the bearing carrier.

The intermediate bearings according to the present invention can be manufactured at lower costs and are less susceptible to corrosion than conventional intermediate bearings.

In a particularly advantageous embodiment, the support opening is manufactured with an enlarged diameter, specifically enlarged in a vertical direction so that the opening is oval and the elastic adjustment component can be vulcanized into bearing carrier at different height levels.

Preferably, the bearing carrier is manufactured from a metal sheet by deep-drawing.

In a preferred embodiment of the method according to the invention, the mounting face areas are formed by the support areas of the bearing carrier whose strength is increased by folding over and doubling the sheet metal so as to form a rigid structure for mounting the bearing carrier to a vehicle body structure.

Preferably, the drive shaft support part and the material forming the filling are vulcanized using a vulcanizing tool, which has been adapted to the dimensions of the level adjustment.

The support part and the material forming the filling can be vulcanized using exchangeable inserts depending on the desired position level of the support part.

The invention will become more readily apparent from the following description of advantageous embodiments and a process for the manufacture thereof on the basis of the accompanying drawings.

### BRIEF DESCRIPTION OF THE DRAWINGS

FIG. 1 shows, in a partially sectional side view, a drive shaft as it is used particularly in motor cars for the connection between a drive unit and a drive axle which is a typical application for the intermediate bearing according to the invention,

FIG. 2 shows a conventional intermediate bearing for a drive shaft in an axial view,

FIG. 3 is a cross-sectional side view of the drive shaft bearing shown in FIG. 2,

FIGS. 4a and 4b are axial views of an intermediate bearing for a drive shaft wherein the center of the bearing is shown in an upper positions (FIG. 4a) and in a lower position (FIG. 4b), and

FIGS. 5a and 5b are cross-sectional side views of the intermediate bearing of FIGS. 4a and 4b for a drive shaft according to an embodiment of the invention, wherein the bearing center is shown in an upper position (FIG. 5a) and in a lower position (FIG. 5b).

### DESCRIPTION OF A PARTICULAR EMBODIMENT

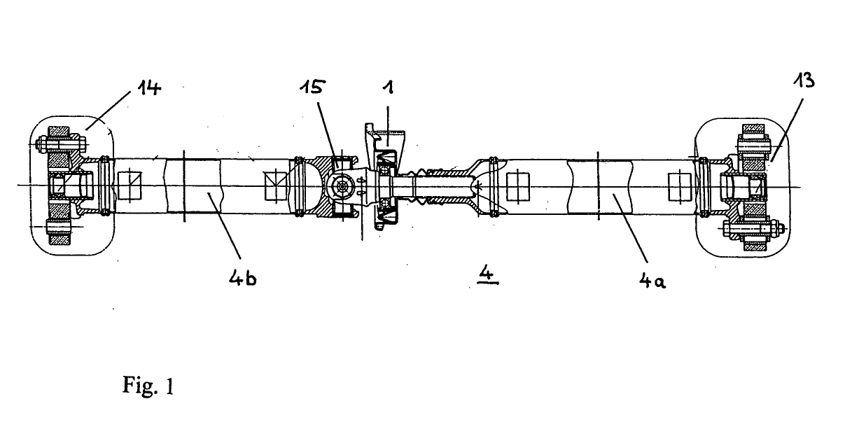

FIG. 1 is a partially sectional side view of an articulated drive shaft 4 as it is used in motor vehicles for the transfer of power from a drive unit 13 to a drive axle, particularly a rear axle differential 14. The drive shaft 4 is divided by a universal joint 15 into an input end partial shaft 4a and an output end partial shaft 4b. In the center area near the joint 15, the drive shaft 4 is supported by means of an intermediate bearing 1 on a vehicle body component which is not shown.

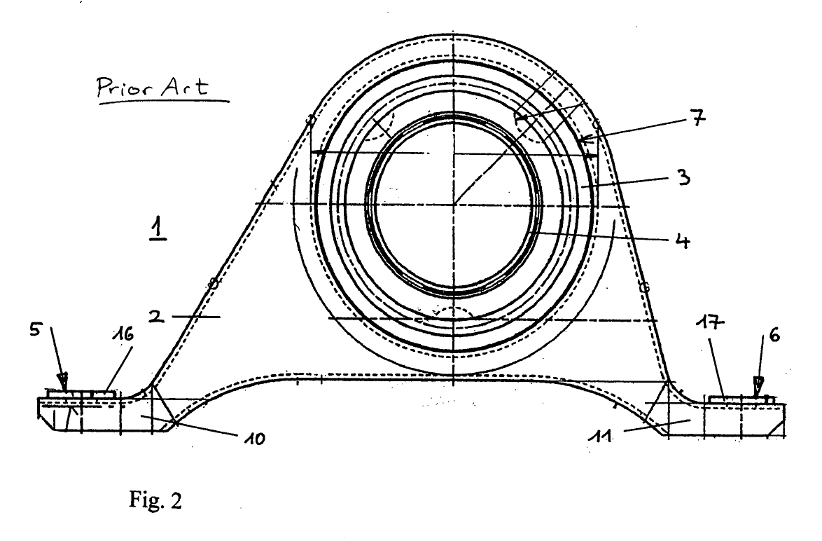

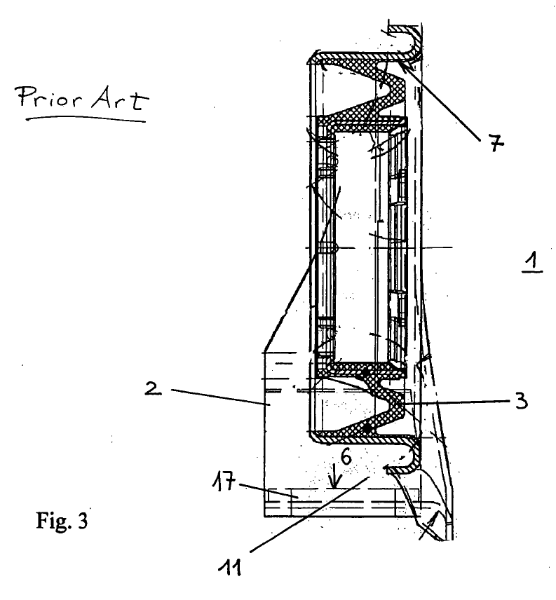

The FIGS. 2 and 3 show an intermediate bearing 1 for an articulated drive shaft 4 according to the state of the art in an axial and, respectively, a sectional side view. The intermediate bearing comprises a bearing carrier 2 with mounting areas 5, 6 on a vehicle component which supports the drive shaft 4 and an elastic support part 3 of a vulcanized material which is disposed in a support opening 7 formed in the bearing carrier in which the drive shaft 4 is resiliently supported. The support part 3 is shown herein in the form of a bellows as it is used frequently in such applications.

Depending on the installation position of the drive shaft 4, it seems to be possible—within limits—to accommodate height differences requiring different positions of the center of the bearing 1, supporting the shaft at different levels. In the intermediate bearing 1 according to the state of the art shown in FIGS. 2 and 3, this is achieved by welding metal plates 16, 17 onto the mounting surfaces 5, 6 of the leg areas 10, 11 of the bearing carrier 2.

As already noted earlier, this type of height adjustment has the disadvantage of causing additional expenses for the welding of the metal plates 16, 17 and, furthermore, of resulting in increased corrosion, particularly crevice corrosion between the leg areas 10, 11 and the metal plates 16, 17.

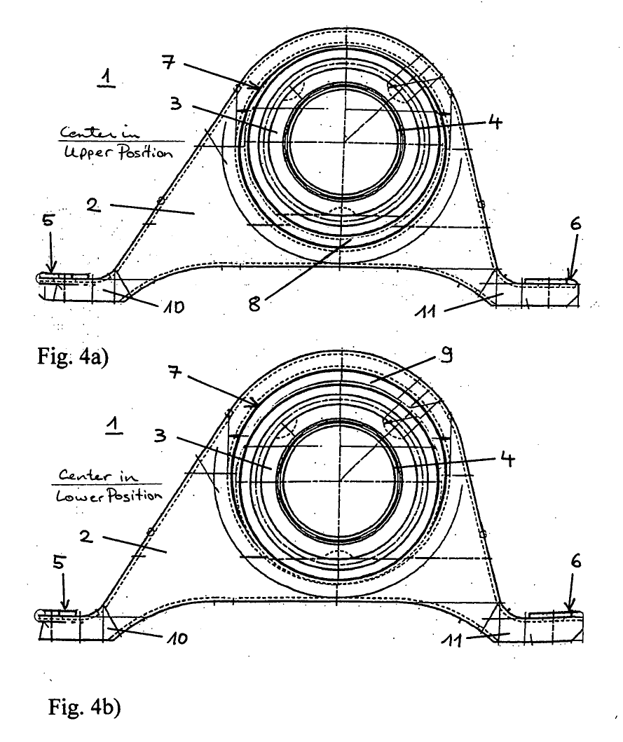

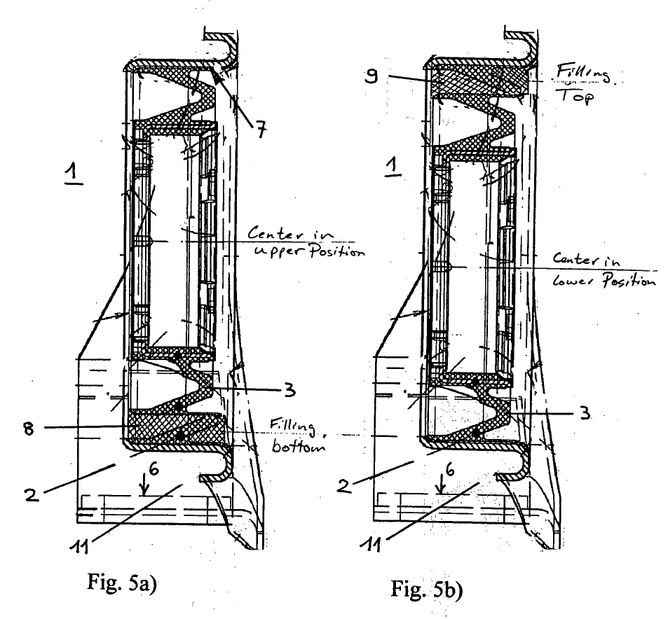

The FIGS. 4a and 4b show each an exemplary embodiment of an intermediate bearing 1 for a drive shaft according to the present invention in an axial view. FIGS. 5a and 5b show them in sectional side views. In these views, the bearing is shown installed with the bearing center in an upper position (FIGS. 4a, 5a) and in a lower position (FIGS. 4b, 5b).

Like in the known intermediate bearing shown in FIGS. 2 and 3, the intermediate bearing 1 comprises a bearing carrier 2 which has mounting surface areas 5, 6 for connection to a vehicle component supporting the drive shaft 4 and an elastic compensation part 3 of a vulcanized material which is received in a support opening 7 formed in the bearing carrier 2 and in which the drive shaft 4 is resiliently supported for the accommodation of its vibrations. Also in this case, the compensation part 3 is in the form of a bellows.

Depending on the installation position of the drive shaft 4, a height adjustment is possible by different positioning of the center of the bearing 1, that is, the center of the support part 3 supporting the shaft at different height levels. To this end, the support opening 7 of the bearing carrier 2 has at least in the vertical direction a greater extension with respect to the elastic support part 3 and the elastic support part 3 can be vulcanized into the opening at different levels with respect to the bearing carrier 2 in accordance with the needed extent of the height compensation.

In the intermediate bearing 1 shown in FIGS. 4a and 5a, the center of the support part 3 and, consequently, the level at which the drive shaft 4 is supported, is disposed in an upper position.

It the intermediate bearing 1 as shown in FIGS. 4b, and 5b, the center of the support part 3 and, consequently, the center in which the drive shaft 4 is supported, is disposed in a lower position.

A filler 8 disposed in the space remaining between the compensation part 3 and the bottom of the basic opening 7 as shown in FIGS. 4a and 5a or respectively, in the space remaining between the support part 3 on the bottom of the support opening 7 as shown in FIGS. 4b and 5b is formed by vulcanized material introduced during vulcanization of the support part 3 into the support opening 7.

In the embodiment of the intermediate bearing 1 as shown in FIGS. 4 and 5, the support opening 7 is a circular opening with a diameter larger than that of the compensation part 3. Alternatively, however, the opening may be enlarged only in a vertical direction so as to have an oval cross-section.

The bearing carrier 2 is manufactured in the exemplary embodiment from a metal sheet by deep-drawing. The mounting surfaces 5, 6 by way of which the bearing carrier 2 is mounted to the component supporting the drive shaft 4, that is, for example a part of a vehicle body of a motor vehicle, are established by the mounting of leg areas 10, 11 of the bearing carrier 2. The strength of the leg areas is increased by folding over and doubling of the sheet metal in the leg areas 10, 11.

The vulcanization of the material forming the vulcanized support part and the filler 8, 9 is performed using a vulcanizing tool adapted to the respective height compensation, particularly a tool with exchangeable inserts adapted to different support heights for the drive shaft.

What is claimed is:

1. An intermediate bearing (1) for a driveshaft (4), comprising a bearing carrier (2) having mounting surface areas (5, 6) for its mounting to a component supporting the drive shaft (4) and defining a support opening (7) and an elastic support part (3) consisting of a vulcanized material and being disposed in the support opening (7) in which the drive shaft (4) is resiliently supported, said support opening (7) having, at least in the vertical direction, an extension exceeding the diameter of the elastic support part (3) and the elastic support part (3) is vulcanized into the support opening (7) in accordance with a desired level at a selected height with respect to the bearing carrier (2), any spaces remaining between the compensation part (3) and the support opening (7) being filled during vulcanization with vulcanizing material, thereby providing for a position of the center of the bearing in the support opening (7) at a pre-selected distance from the mounting surface areas (5, 6).

2. An intermediate bearing according to claim 1, wherein both, the support opening (7) and the elastic support part (3), are circular and the elastic support part (3) is disposed eccentrically in the support opening which is larger in diameter than the elastic compensation part (3) and any space between the elastic support part (3) and the structure defining the support opening (7) is filled with vulcanizing material.

3. An intermediate bearing according to claim 1, wherein the support opening (7) is elongated and the elastic support part (3) is disposed eccentrically in the support opening (7) and any space between the elastic support part (3) and the structure defining the support opening (7) is filled with vulcanizing material.

4. An intermediate bearing according to claim 1, wherein the bearing carrier (2) is a deep-drawn sheet metal component.

5. An intermediate bearing according to claim 4, wherein the mounting surfaces (4, 6) are formed on legs (10, 11) of the bearing carrier (2) and the strength of the legs (10, 11) is increased by folding over and doubling the metal sheet in the leg area.

6. A method for the manufacture of an intermediate bearing for a drive shaft (4) comprising a bearing carrier (2) having mounting surface areas (5, 6) and a support opening (7) accommodating an elastic support part (3) by way of which the drive shaft (4) is resiliently supported at a predetermined distance from the level of the mounting surface areas (5, 6), said method comprising the steps of: providing the support opening (7) at least in the vertical direction with an extension exceeding the diameter of the elastic support part (3), vulcanizing the elastic support part into the support opening (7) at a desired height level over the level of the mounting surfaces (5, 6) and, at the same time, filling any space remaining between the support part (3) in the support opening (7) with additional vulcanizing material for firmly supporting the elastic support part in the support opening (7) at the desired height level.

7. A method according to claim 6, wherein the support opening (7) as well as the elastic support part (3) are circular but the elastic support part (3) is smaller in diameter than the support opening (7) and is vulcanized into the support opening eccentrically depending on the desired height level over the level of the mounting surfaces.

8. A method according to claim 6, wherein the support opening (7) is elongated in a vertical direction and the elastic support part (3) is vulcanized into the support opening eccentrically depending on the desired height level over the level of the mounting surfaces.

9. A method according to claim 6, wherein the bearing carrier (2) is deep-drawn from a sheet metal.

10. A method according to claim 6, wherein the mounting surfaces (5, 6) are formed on leg areas (10, 11) of the bearing carrier (2), and the sheet metal is folded and doubled in the leg areas in order to increase the strength of the legs (10, 11).

11. A method according to claim 6, wherein the support part (3) comprises a bellows and a filler part (8, 9) which are vulcanized jointly into the support opening using a vulcanizing tool adapted to the desired height level of the support part (3) over the level of the mounting surfaces (5, 6).

12. A method according to claim 11, wherein exchangeable inserts are used as vulcanizing tools during the vulcanizing of the bellows (3) and the filler part (8, 9).
